(19) United States
(12) Patent Application Publication
(10) Pub. No.: US 2015/0237328 A1
(43) Pub. Date: Aug. 20, 2015

(54) METHOD FOR GENERATING THREE-DIMENSIONAL IMAGES AND THREE-DIMENSIONAL IMAGING DEVICE

(71) Applicant: Dayu Optoelectronics Co., Ltd., Xinwu Township (TW)

(72) Inventors: Der-Hsing LIOU, Xinwu Township (TW); Shu-Shuo HSU, Xinwu Township (TW); Yu-Chieh CHEN, Xinwu Township (TW)

(73) Assignee: Dayu Optoelectronics Co., Ltd., Xinwu Township (TW)

(21) Appl. No.: 14/275,079

(22) Filed: May 12, 2014

(30) Foreign Application Priority Data
Feb. 14, 2014 (TW) 103104969

(51) Int. Cl. H04N 13/02; H04N 5/232; G06T 7/00

(52) U.S. Cl. CPC H04N 13/0217; G06T 7/0075; H04N 5/23225; H04N 2013/0074

(57) ABSTRACT

A method for generating three-dimensional images is provided. The method is used for a three-dimensional imaging device including a touch panel and a single lens. The method includes steps of: the touch panel showing a image including a predetermined path; using the single lens to shoot at least two different plane images when detecting a contact point on the touch panel moving along the predetermined path; and outputting the at least two different plane images shot by the single lens to make the touch panel show a three-dimensional image.

### CROSS-REFERENCE TO RELATED APPLICATIONS

This non-provisional application claims priority under 35 U.S.C. §119(a) on Patent Application No(s). 103104969 filed in Taiwan, R.O.C. on Feb. 14, 2014, the entire contents of which are hereby incorporated by reference.

### TECHNICAL FIELD

The disclosure relates to a method for generating images and an imaging device, more particularly to a method for generating three-dimensional images and a three-dimensional imaging device.

### BACKGROUND

Nowadays a three-dimensional photo is usually shot by a three-dimensional imaging device with double lenses. The three-dimensional imaging device with double lenses usually has two sets of shooting modules which are separated apart by a distance. Specifically, one set of shooting module is acting like a left eye of a human being while the other set of shooting module is acting like a right eye of the human being. This three-dimensional imaging device with double lenses, however, is costly because it requires two sets of shooting modules.

To address this issue, another way to shoot three-dimensional images is introduced. In this method, an imaging device with a single lens is utilized. Specifically, a user uses it to shoot the first photo, and then move it by a horizontal distance and rotate it through an angle to shoot the second one. The horizontal distance is approximately equal to the distance between both eyes. However, this method is hard to control and may require certain jigs to complete the processes so it is inconvenient.

### SUMMARY

A method for generating three-dimensional images is provided. The method is configured for a three-dimensional imaging device comprising a touch panel and a single lens. The method comprises steps of: the touch panel showing a image comprising a predetermined path; using the single lens to shoot at least two different plane images when detecting a contact point on the touch panel moving along the predetermined path; outputting the at least two different plane images shot by the single lens to make the touch panel show a three-dimensional image.

A three-dimensional imaging device comprises a single lens, a touch panel for displaying an image comprising a predetermined path, and a processing unit coupled to the single lends and the touch panel. The single lens shoots at least two different plane images when detecting a contact point on the touch panel moving along the predetermined path. The processing unit outputs the at least two different plane images shot by the single lens to make the touch panel show a three-dimensional image.

### BRIEF DESCRIPTION OF THE DRAWINGS

The present disclosure will become more fully understood from the detailed description and the drawings given herein below for illustration only, and thus does not limit the present disclosure, wherein:

FIG. 1A is a perspective view of a three-dimensional imaging device according to an embodiment of the disclosure;

FIG. 1B is a block diagram of the three-dimensional imaging device according to the embodiment of the disclosure;

FIG. 2 is a flow chart of the method for generating three dimensional images according to the embodiment of the disclosure;

FIG. 3 to FIG. 4 are schematic views of the contact point moving along the predetermined path and locating at different positions according to the embodiment of the disclosure; and

FIG. 5 to FIG. 6 are schematic views of the contact point moving along the predetermined path and locating at different positions according to another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

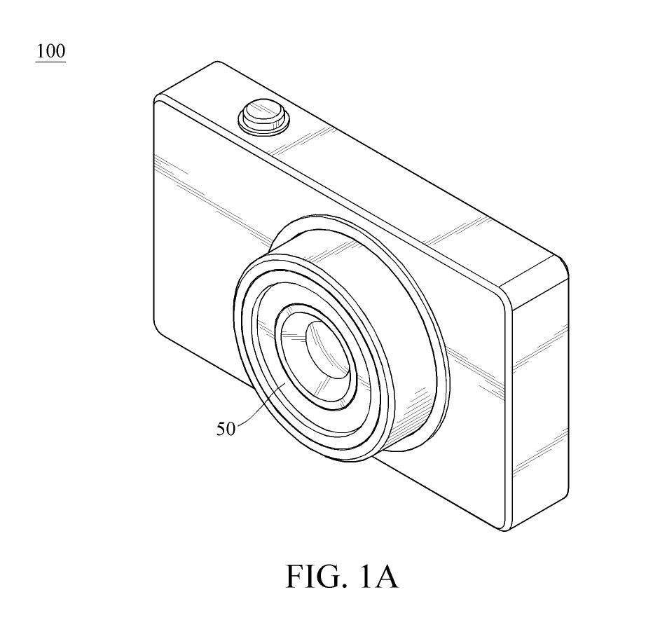

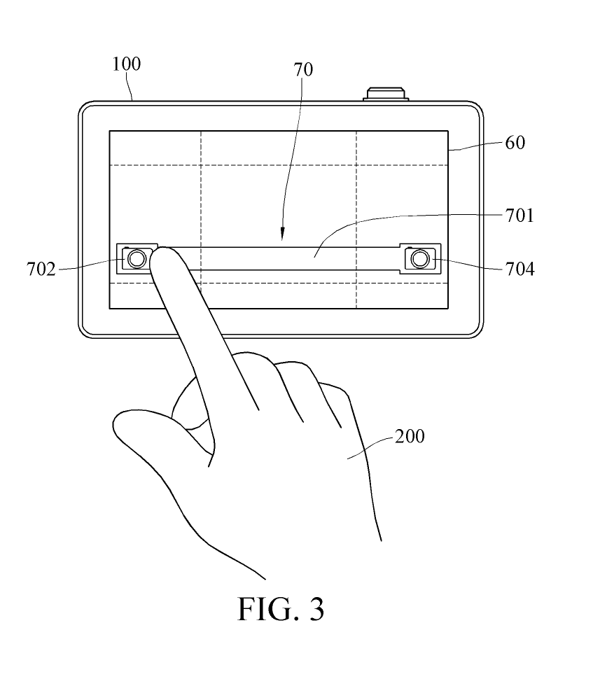

FIG. 1A is a perspective view of a three-dimensional imaging device according to an embodiment of the disclosure; FIG. 1B is a block diagram of the three-dimensional imaging device according to the embodiment of the disclosure. As seen in FIG. 1A and FIG. 1B, the three-dimensional imaging device 100 comprises a single lens 50, a touch panel 60 and a processing unit 30. The touch panel 60 is used to show an image 70 (as shown in FIG. 3). The processing unit 30 is coupled to the single lens 50 and the touch panel 60. The image 70 comprises a predetermined path 701, a start mark 702 and an end mark 704. The start mark 702 and the end mark 704 are located on the two ends of the predetermined path 701. In this embodiment, the three-dimensional imaging device 100 may be a camera with the touch panel and the single lens. The touch panel 60 may be a capacitive touch panel while the predetermined path 701 may be a straight line, but the disclosure is not limited thereto. In other embodiments, the three-dimensional imaging device 100 may be a cell phone or a tablet computer each with the touch panel and the single lens, while the touch panel 60 may be a resistive touch panel. In addition, the predetermined path 701 may be a parabola or a curve.

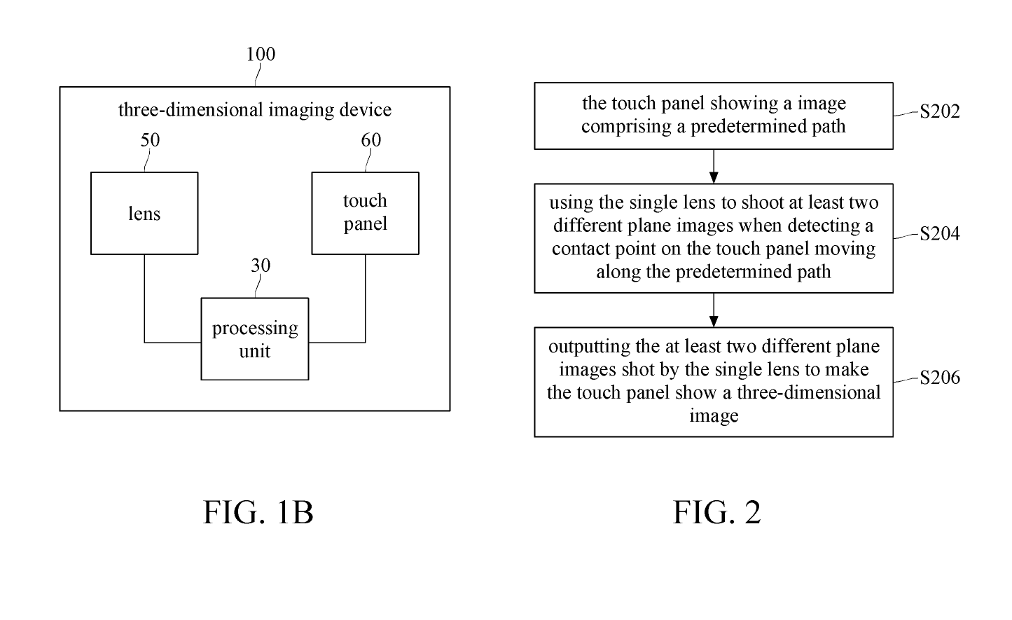

FIG. 2 is a flow chart of the method for generating three dimensional images according to the embodiment of the disclosure. As shown in FIG. 1B and FIG. 2, in this embodiment, the method for generating three dimensional images is configured for the three-dimensional imaging device 100. The method for generating three dimensional images comprises the steps of:

S202: the touch panel showing an image comprising a predetermined path.

S204: using the single lens to shoot at least two different plane images when detecting a contact point on the touch panel moving along the predetermined path.

S206: outputting the at least two different plane images shot by the single lens to make the touch panel show a three-dimensional image.

In this embodiment, since the touch panel 60 is a capacitive touch panel so that the contact point is a point where a hand 200 of a user or a capacitive pen touches the touch panel, but the disclosure is not limited thereto. When the touch panel 60 is a resistive touch panel, the contact point could be a point where a stylus touches the touch panel 60.

When the processing unit 30 of the three-dimensional imaging device 100 detects that the contact point of the touch panel 60 moves along the predetermined path 701, the single lens 50 shoots at least two different plane images (that is, the step S204). Subsequently, the processing unit 30 outputs the at least two different plane images shot by the single lens 50, thereby making the touch panel 60 show a three-dimensional image (namely the step S206).

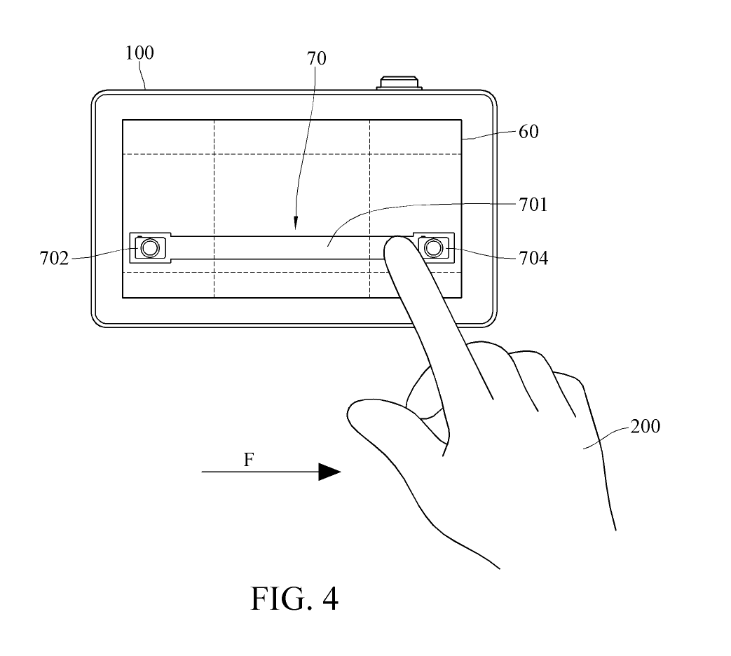

FIG. 3 to FIG. 4 are schematic views of the contact point moving along the predetermined path and locating at different positions according to the embodiment of the disclosure. As seen in FIG. 3 and FIG. 4, when the three-dimensional imaging device 100 is ready to shoot, the touch panel 60 shows the image 70 (namely the step S202). Then, the hand 200 touches the touch panel 60 so that the processing unit 30 detects a contact point. When the processing unit 30 detects that the contact point of the touch panel 60 slides from the start mark 702 to the end mark 704 (the touch contact slides linearly along a first direction F, namely along the predetermined path 701), at least two plane images can be shot via the single lens 50 because the three-dimensional imaging device 100 tilts slightly (S204). Subsequently, the processing unit 30 outputs the at least two plane images shot via the single lens 50 to make the touch panel 60 display a three-dimensional image (namely the step S206).

The contact point moves along the predetermined path 701 is completed by the hand 200 sliding on the touch panel 60 relative to the three-dimensional imaging device 100 (that is, the three-dimensional imaging device 100 is kept still while the hand 200 slides on the touch panel 60 along the predetermined path 701). However, the disclosure is not limited thereto. In other embodiments, the movement of the contact point along the predetermined path 701 can be completed by the three-dimensional imaging device 100 moving relative to the contact point (that is, the hand 200 is kept still on the touch panel while the user move the three-dimensional imaging device 100 along the predetermined path 701).

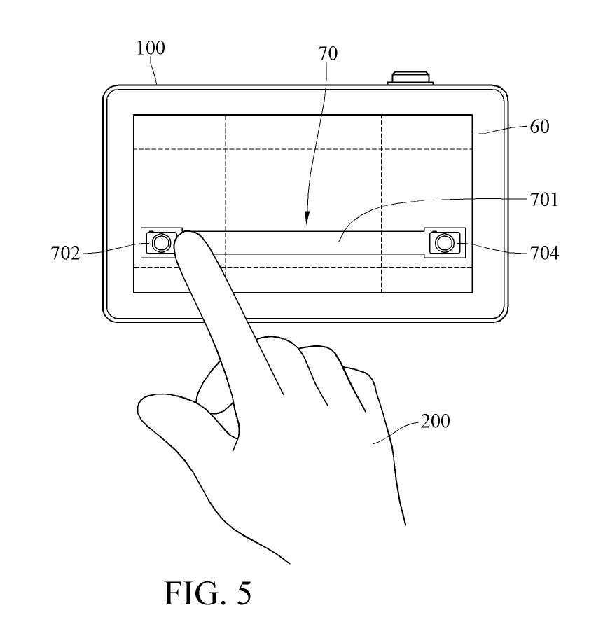

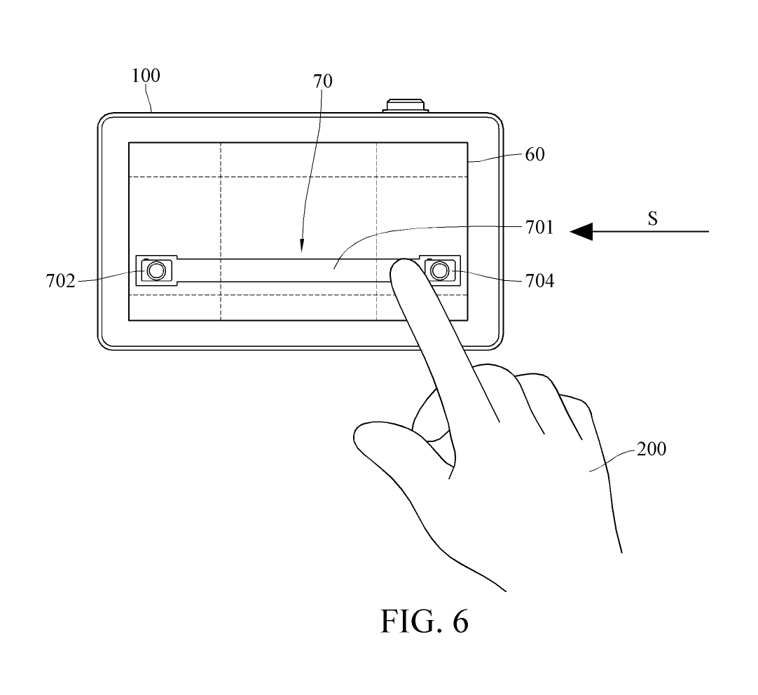

FIG. 5 to FIG. 6 are schematic views of the contact point moving along the predetermined path and locating at different positions according to another embodiment of the disclosure. As seen in FIG. 2, FIG. 5 and FIG. 6, in this embodiment, when the three-dimensional imaging device 100 is ready to shoot, the touch panel 60 shows the image 70 (namely the step S202). Then, the hand 200 touches the touch panel 60 so that the processing unit 30 detects a contact point. When the processing unit 30 detects that the contact point of the touch panel 60 slides from the start mark 702 to the end mark 704 (the touch contact slides linearly along a second direction S, namely along the predetermined path 701), at least two plane images may be shot via the single lens 50 because the three-dimensional imaging device 100 tilts slightly (S204). Subsequently, the processing unit 30 outputs the at least two plane images shot via the single lens 50 to make the touch panel 60 display a three-dimensional image (namely the step S206).

In the aforementioned two embodiments, the method for generating three-dimensional images may further comprise: saving the at least two different plane images shot via the single lens 50. Specifically, in step S204, when the single lens shoots at least two different plane images, the processing unit 30 can arrange them side by side, either vertically or horizontally. Additionally, when the single lens shoots at least two different plane images, the processing unit 30 may save them as MPO (Multi Picture Object) files.

In the method for generating three-dimensional images and the three-dimensional imaging device according to the disclosure, the single lens can shoot at least two plane images simply by the contact point on the touch panel moving along the predetermined path. Thereby, the touch panel is made to show the three-dimensional images, which solves the problems illustrated in the background.

What is claimed is:

1. A method for generating three-dimensional images configured for a three-dimensional imaging device comprising a touch panel and a single lens, comprising steps of:
the touch panel showing a image comprising a predetermined path;
using the single lens to shoot at least two different plane images when detecting a contact point on the touch panel moving along the predetermined path; and
outputting the at least two different plane images shot by the single lens to make the touch panel show a three-dimensional image.

2. The method for generating three-dimensional images according to claim 1, further comprising: the touch panel showing an operation tip when detecting the contact point not moving along the predetermined path.

3. A three-dimensional imaging device comprising:
a single lens;
a touch panel for displaying an image comprising a predetermined path; and
a processing unit coupled to the single lends and the touch panel;
wherein the single lens shoots at least two different plane images when detecting a contact point on the touch panel moving along the predetermined path, and the processing unit outputs the at least two different plane images shot by the single lens to make the touch panel show a three-dimensional image.

4. The three-dimensional imaging device according to claim 3, wherein the image further comprises a start mark and an end mark located on the two ends of the predetermined path respectively.
